(19) United States
(12) Patent Application Publication
(10) Pub. No.: US 2016/0111828 A1
(43) Pub. Date: Apr. 21, 2016

(54) USB DEVICE

(71) Applicant: CviLux Corporation, New Taipei City (TW)

(72) Inventor: Kai-Hsiang CHOU, New Taipei City (TW)

(21) Appl. No.: 14/832,032

(22) Filed: Aug. 21, 2015

(30) Foreign Application Priority Data
Oct. 15, 2014 (TW) 103218229

(51) Int. Cl. H01R 13/66; H01R 13/44; H01R 27/02

(52) U.S. Cl. CPC H01R 13/665; H01R 27/02; H01R 13/44

(57) ABSTRACT

A USB device having a circuit board, a control board, an inner housing, a outer housing and a front cover and a rear cover is provided. The circuit board has a first connector and a second connector disposed opposite to the first connector. The control board is disposed on the circuit board. The inner housing is used for receiving the circuit board and the control board. The outer housing has a front side and a rear side, and the outer housing is used for covering the inner housing. The front cover and the rear cover are disposed on the front side of the outer housing and the rear side of the outer housing respectively. By combining the control board and the inner housing, the circuit board is slidably disposed within the inner housing.

This application claims the benefit of the priority based on Taiwan Patent Application No. 103218229 filed on Oct. 15, 2014, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to a USB device, and more particularly, to a USB device with two different connectors.

2. Descriptions of the Related Art

The USB device used in the current technology merely has a single connector, and the single connector is usually a standard USB connector. As a result, the USB device can only be used to transfer files to the apparatus (such as the personal computer and the laptop) which has the connector corresponding to the standard USB connector.

However, with the rise of the new generation of the smart phones and the tablet devices, in order to comply with their lightweight characteristics and achieve the purpose of miniaturization, these new generation of smart phones or tablet devices have used Min-USB or Micro-USB connector for transferring the file data.

Thus, since the used connectors are with different types, it is difficult for the user to use the USB device of the current technology to both the personal computer/laptop and the smart phone/tablet device.

In view of this, it is important to provide a USB device with two different connectors, and thus the USB device is common used to both the personal computer/laptop and the smart phone/tablet device to avoid the above stuck case.

### SUMMARY OF THE INVENTION

An objective of the present invention is to provide a USB device with two different connectors to assist the transference of the file data between the personal computer/laptop and the smart phone/tablet device.

To achieve the aforesaid objective, a USB device having a circuit board, a control board, an inner housing, a outer housing and a front cover and a rear cover is provided. The circuit board has a first connector and a second connector disposed opposite to the first connector. The control board is disposed on the circuit board. The inner housing is used for receiving the circuit board and the control board. The outer housing has a front side and a rear side, and the outer housing is used for covering the inner housing. The front cover and the rear cover are disposed on the front side of the outer housing and the rear side of the outer housing respectively. By combining the control board and the inner housing, the circuit board is slidably disposed within the inner housing.

To achieve the aforesaid objective, in this invention, both the left side and the right side of the control board have an engaging block and a sliding block, both the left side and the right side of the inner housing have a plurality of engaging grooves and a sliding groove, the engaging block is corresponded to the engaging grooves, and the sliding block is corresponded to the sliding groove.

To achieve the aforesaid objective, in this invention, the engaging grooves are a central engaging groove, a front side engaging groove and a rear side engaging groove, which make the control board controlling the circuit board to be disposed at a central position, a front side position and a rear side position accordingly.

To achieve the aforesaid objective, in this invention, when the circuit board is disposed at the central position, the first connector and the second connector are in a storage state, and the engaging block is adapted to be fixed with the central engaging groove.

To achieve the aforesaid objective, in this invention, when the circuit board is disposed at the front side position, the first connector is in a exposed state, and the engaging block is adapted to be fixed with the front side engaging groove.

To achieve the aforesaid objective, in this invention, when the circuit board is disposed at the rear side position, the second connector is in a exposed state, and the engaging block is adapted to be fixed with the rear side engaging groove.

To achieve the aforesaid objective, in this invention, a adjust button is disposed on the control board, and the adjust button is exposed to the outer housing via an opening.

To achieve the aforesaid objective, in this invention, the adjust bottom is adjustable to move the engaging block to the central engaging groove, the front side engaging groove and the rear side engaging groove by pressing the adjust bottom.

To achieve the aforesaid objective, in this invention, the first connector and the second connector are any two of USB connector, Mini-USB connector, Micro-USB connector and Lightning connector.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a USB device according to the present invention;

FIG. 2 is an exploded view of the USB device according to the present invention;

FIG. 3 is another schematic view of the control board of the USB device according to the present invention;

FIG. 4 is a cross-sectional view of the USB device according to the present invention, when the engaging block of the USB device is fixed in the central engaging groove;

FIG. 5 is a cross-sectional view of the USB device according to the present invention, when the engaging block of the USB device is fixed in the front side engaging groove;

FIG. 6 is a cross-sectional view of the USB device according to the present invention, when the engaging block of the USB device is fixed in the rear side engaging groove;

FIG. 7 is a schematic view of the USB device according to the present invention, when the first connector of the USB device is in an exposed state; and

FIG. 8 is a schematic view of the USB device according to the present invention, when the second connector of the USB device is in an exposed state.

### DESCRIPTION OF THE PREFERRED EMBODIMENT

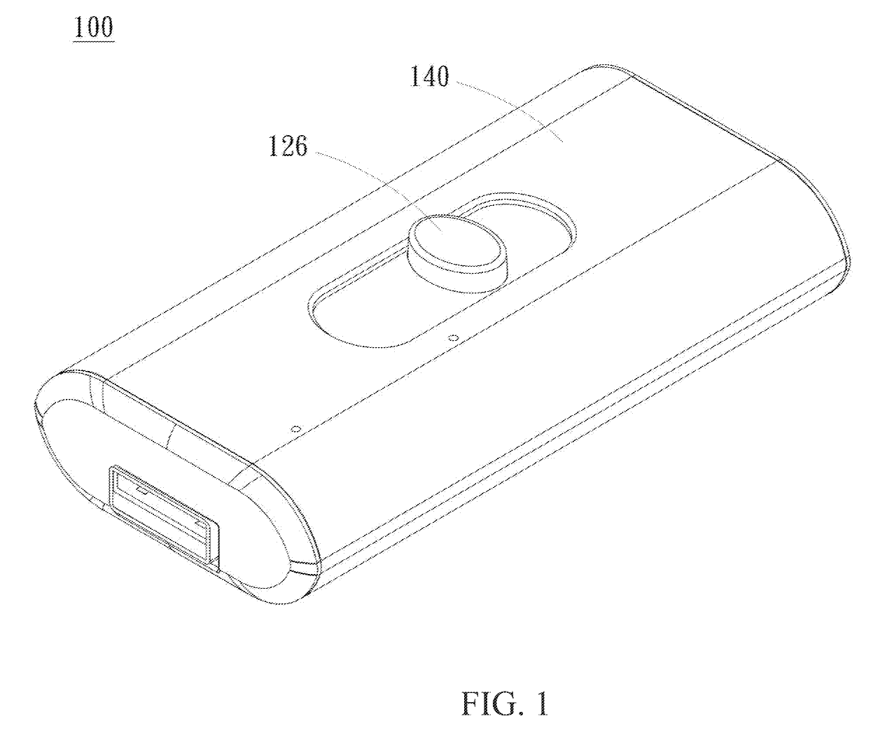

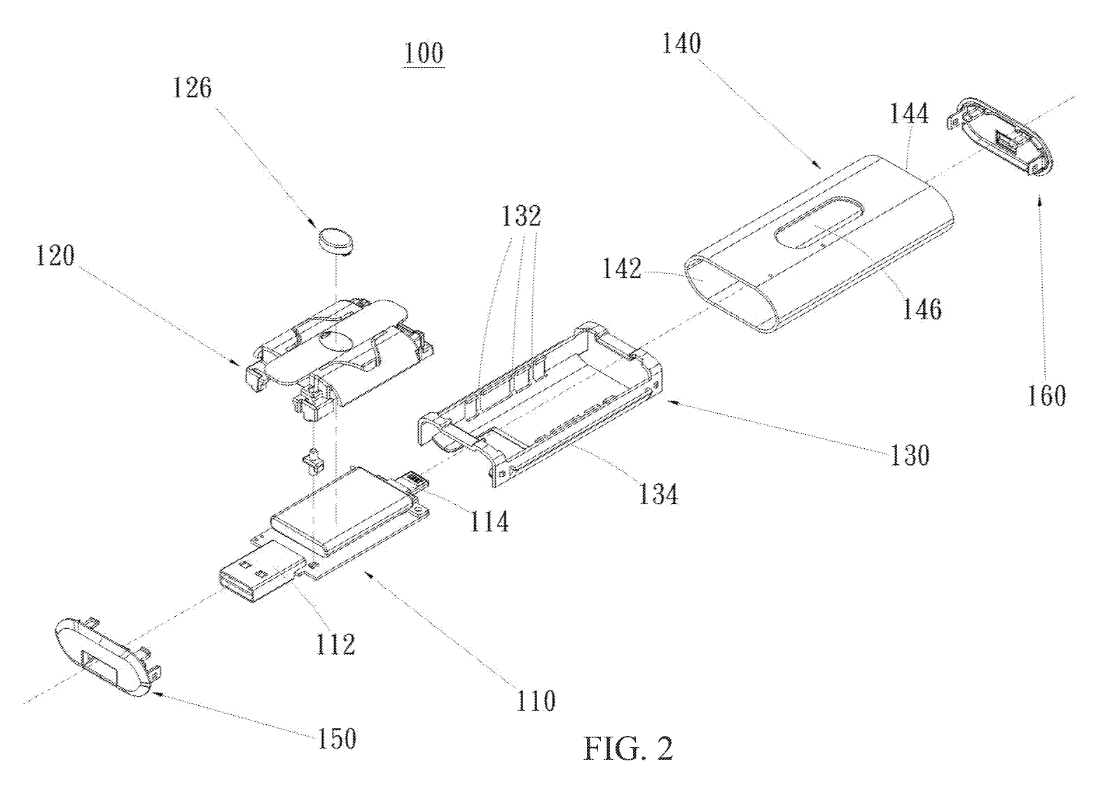

With reference to FIGS. 1 and 2, a USB device 100 of the present invention has a circuit board 110, a control board 120, an inner housing 130, a outer housing 140, a front cover 150 and a rear cover 160.

In detail, as shown in FIG. 2, the circuit board 110 has a first connector 112 and a second connector 114 disposed opposite to the first connector 112. The control board 120 is disposed on the circuit board 110. The inner housing 130 is used for receiving the circuit board 110 and the control board 120. The outer housing 140 has a front side 142 and a rear side 144, and thus the outer housing 140 is used for covering the inner housing 130. The front cover 150 and the rear cover 160 are disposed on the front side 142 and the rear side 144 of the outer housing 140 respectively. As a result, by combining the control board 120 and the inner housing 130, the circuit board 110 is slidably disposed within the inner housing 130.

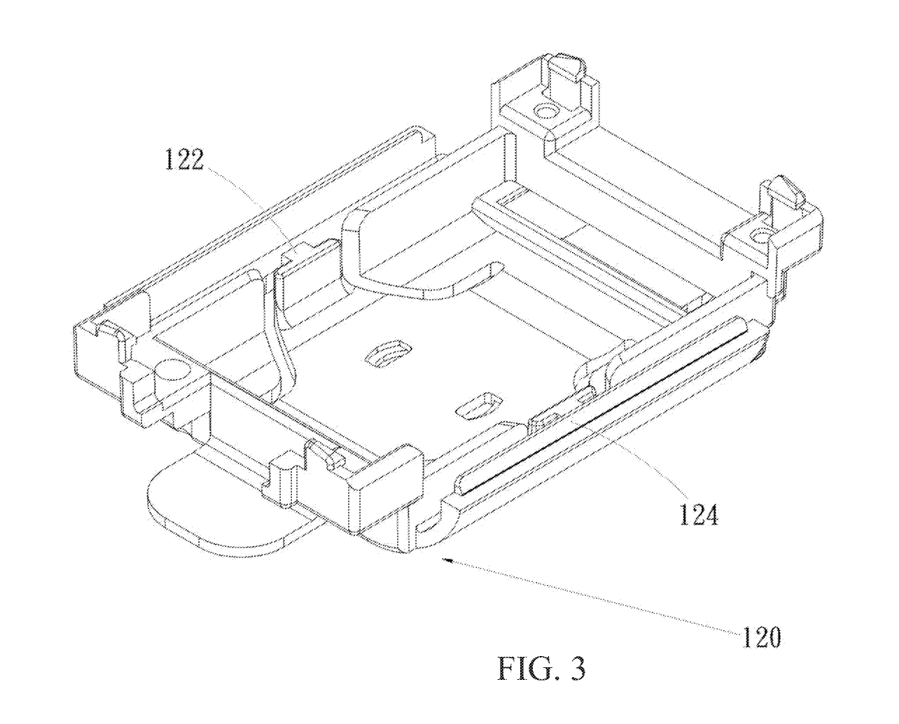

As shown in FIG. 3, both the left side and the right side of the control board 120 in the USB device 100 of the present invention have an engaging block 122 and a sliding block 124. As shown in FIG. 2, both the left side and the right side of the inner housing 130 have a plurality of engaging grooves 132 and a sliding groove 134. The engaging block 122 of the control board 120 is corresponded to the engaging grooves 132 of the inner housing 130, and the sliding block 124 of the control board 120 is corresponded to the sliding groove 134 of the inner housing 130.

In a preferred embodiment of the application, the engaging grooves 132 of the USB device 100 has a central engaging groove 132a, a front side engaging groove 132b and a rear side engaging groove 132c, which make the control board 120 controls the circuit board 110 to be disposed at a central position, a front side position and a rear side position accordingly.

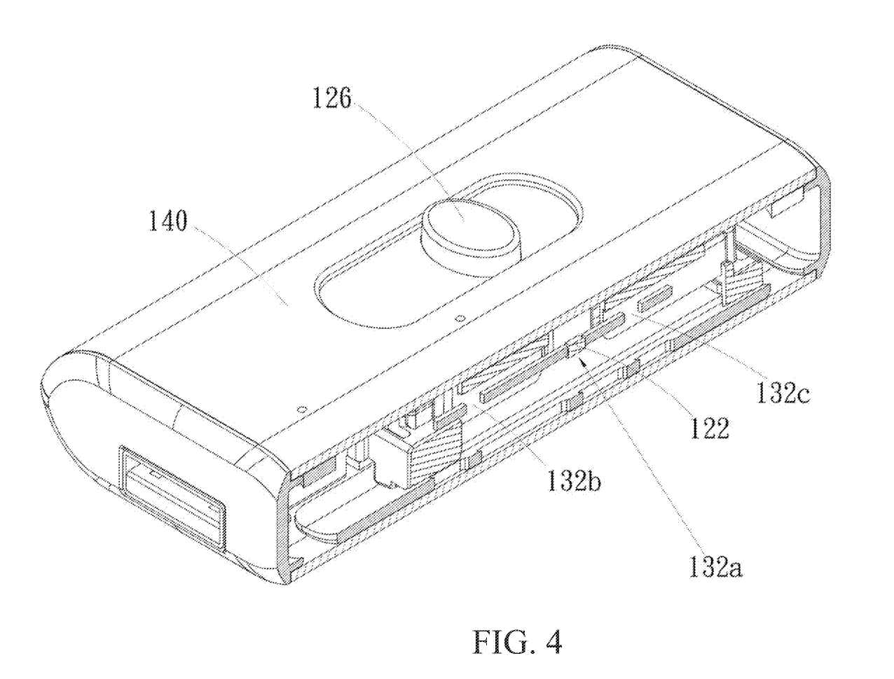

Therefore, as shown in FIG. 4, when the circuit board 110 of the USB device 100 is disposed at the central position, the first connector 112 and the second connector 114 are in a storage state, and the engaging block 122 of the control board 120 is adapted to be fixed with the central engaging groove 132a of the inner housing 130. Thus, this arrangement can avoid the first connector 112 and the second connector 114 with improper sliding, so as to avoid the damage to the first connector 112 and the second connector 114 by the external force.

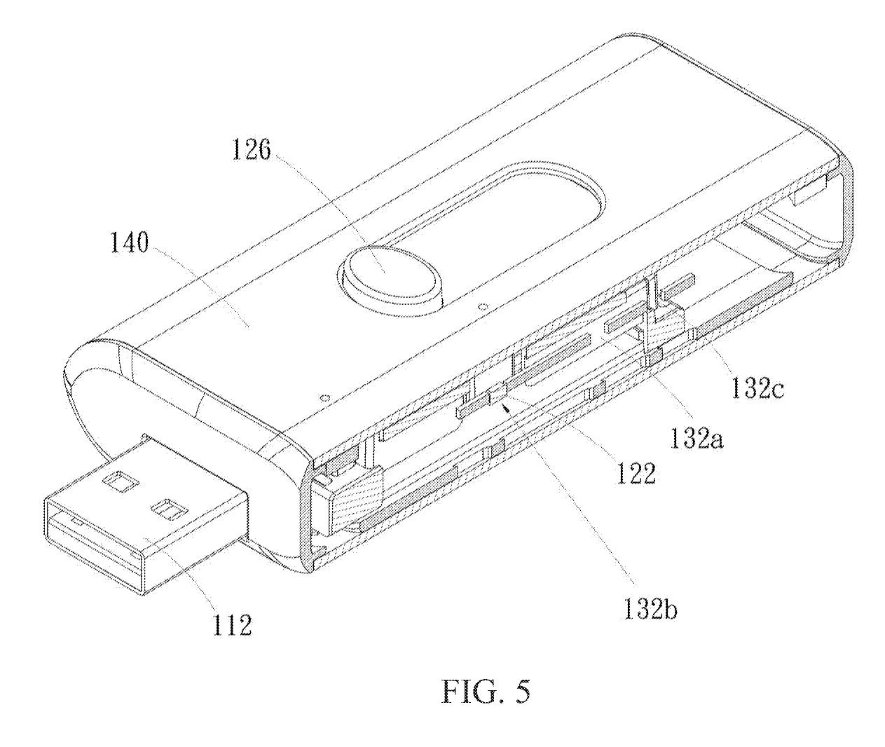

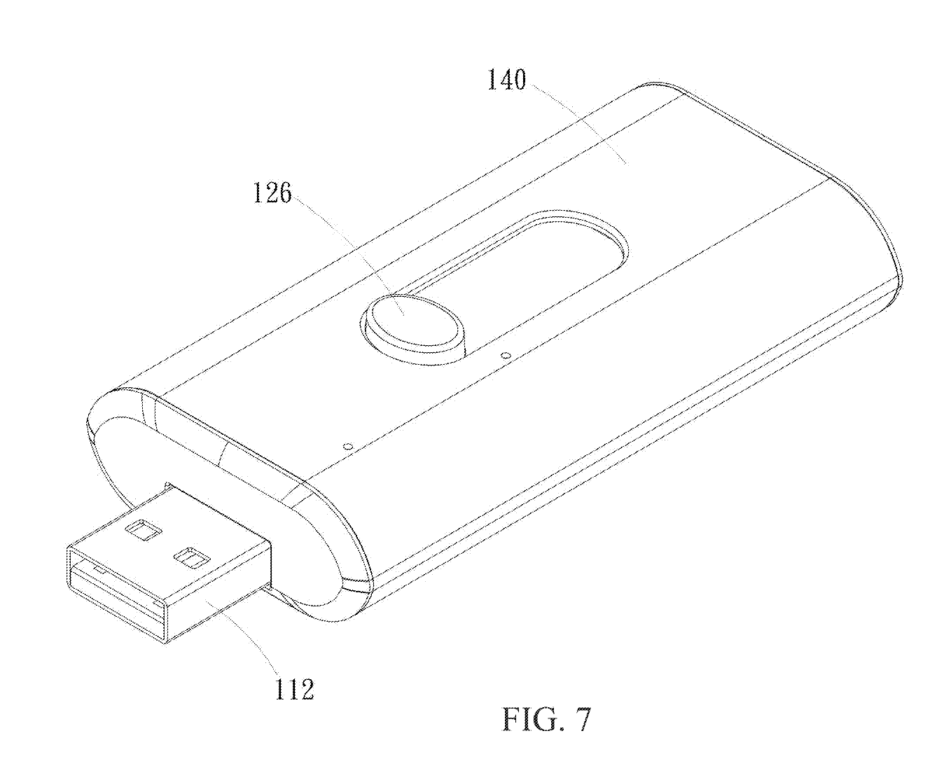

With reference to FIGS. 5 and 7, when the circuit board 110 of the USB device 100 is disposed at the front side position, the first connector 112 is in a exposed state, the engaging block 122 of the control board 120 is adapted to be fixed with the front side engaging groove 132b of the inner housing 130, and so as to avoid the sliding of the first connector 112 while the USB device 100 is using.

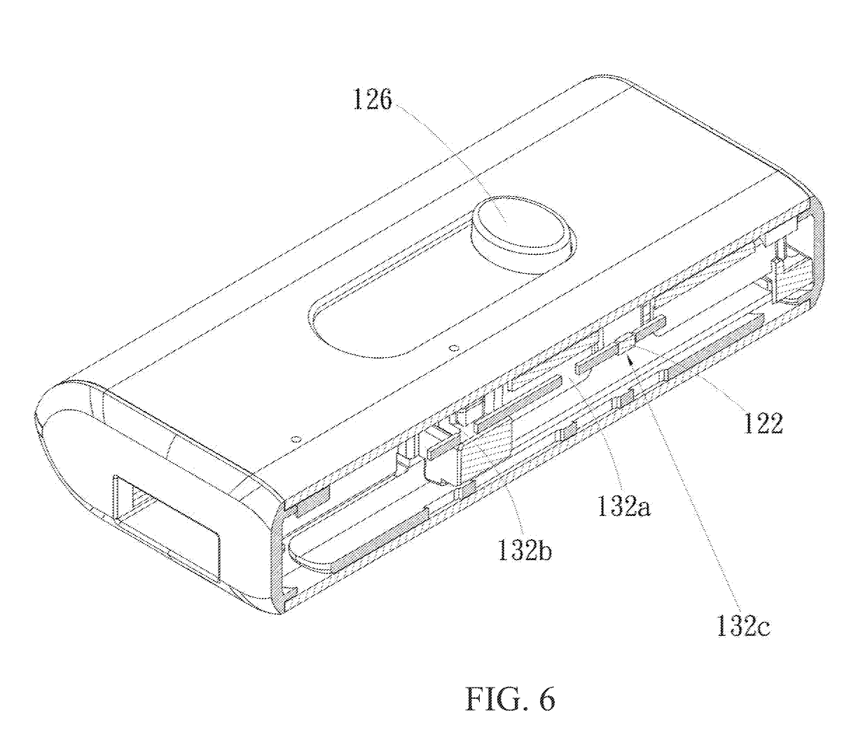

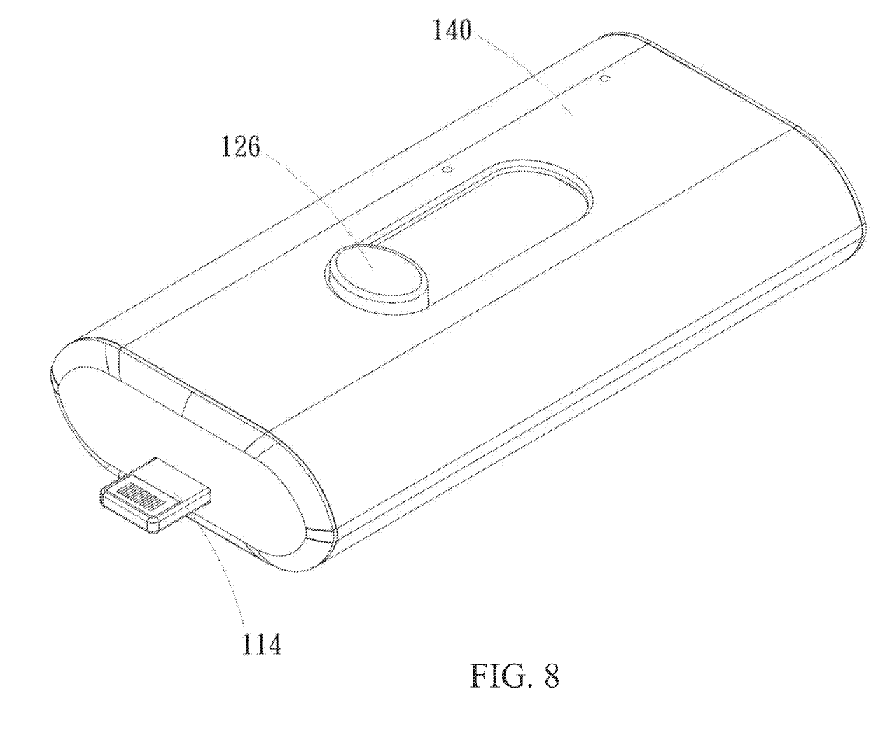

Finally, as shown in FIGS. 6 and 8, when the circuit board 110 of the USB device 100 is disposed at the rear side position, the second connector 114 is in a exposed state, and the engaging block 122 of the control board 120 is adapted to be fixed with the rear side engaging groove 132c of the inner housing 130, and so as to avoid the sliding of the second connector 114 while the USB device 100 is using.

Preferably, the control board 120 of the USB device 100 further has a adjust button 126 disposed on the control board 120. The adjust button 126 is exposed to the outer housing 140 via an opening 146. The adjust bottom 126 is adjustable to move the engaging block 122 of the USB device 100 to the central engaging groove 132a, the front side engaging groove 132b and the rear side engaging groove 132c by pressing the adjust bottom 126. As a result, the circuit board 110 is disposed at the central position, the front side position and the rear side position accordingly.

As person skilled in the art known, the first connector 112 and the second connector 114 of the USB device 100 are any two of USB connector, Mini-USB connector, Micro-USB connector and Lightning connector. Therefore, the first connector 112 and the second connector 114 of the USB device 100 can be used for devices with different types of connectors.

As mentioned above, since the first connector 112 and the second connector 114 of the USB device 100 can be exposed to the front side and the rear side accordingly to be electrical connected with different apparatus for transferring the file data, the USB device 100 of the present invention thus can increase the flexibility of use and accelerate the speed of file data transferring between different devices.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A USB device, comprising:
a circuit board, having a first connector and a second connector disposed opposite to the first connector;
a control board, being disposed on the circuit board;
an inner housing, being used for receiving the circuit board and the control board;
a outer housing, having a front side and a rear side, and the outer housing is used for covering the inner housing; and
a front cover and a rear cover, being disposed on the front side of the outer housing and the rear side of the outer housing respectively;
wherein by combining the control board and the inner housing, the circuit board is slidably disposed within the inner housing.

2. The USB device as claimed in claim 1, wherein both the left side and the right side of the control board have an engaging block and a sliding block, both the left side and the right side of the inner housing have a plurality of engaging grooves and a sliding groove, the engaging block is corresponded to the engaging grooves, and the sliding block is corresponded to the sliding groove.

3. The USB device as claimed in claim 2, wherein the engaging grooves are a central engaging groove, a front side engaging groove and a rear side engaging groove, which make the control board controlling the circuit board to be disposed at a central position, a front side position and a rear side position accordingly.

4. The USB device as claimed in claim 3, wherein when the circuit board is disposed at the central position, the first connector and the second connector are in a storage state, and the engaging block is adapted to be fixed with the central engaging groove.

5. The USB device as claimed in claim 3, wherein when the circuit board is disposed at the front side position, the first connector is in an exposed state, and the engaging block is adapted to be fixed with the front side engaging groove.

6. The USB device as claimed in claim 3, wherein when the circuit board is disposed at the rear side position, the second connector is in an exposed state, and the engaging block is adapted to be fixed with the rear side engaging groove.

7. The USB device as claimed in claim 3, wherein a adjust button is disposed on the control board, and the adjust button is exposed to the outer housing via an opening.

8. The USB device as claimed in claim 7, wherein the adjust bottom is adjustable to move the engaging block to the central engaging groove, the front side engaging groove and the rear side engaging groove by pressing the adjust bottom.

9. The USB device as claimed in claim 1, wherein the first connector and the second connector are any two of USB connector, Mini-USB connector, Micro-USB connector and Lightning connector.
